(19) United States
(12) Patent Application Publication
(10) Pub. No.: US 2026/0075258 A1
(43) Pub. Date: Mar. 12, 2026

(54) Method of Error Handling for Video Bitstream and System Thereof

(71) Applicant: MEDIATEK INC., Hsinchu City (TW)

(72) Inventor: Yu-Hsuan Shih, Hsinchu City (TW)

(73) Assignee: MEDIATEK INC., Hsinchu City (TW)

(21) Appl. No.: 19/315,847

(22) Filed: Sep. 1, 2025

Related U.S. Application Data
(60) Provisional application No. 63/693,269, filed on Sep. 11, 2024.

(51) Int. Cl. H04N 19/895; H04N 19/172; H04N 19/44

(52) U.S. Cl. CPC H04N 19/895; H04N 19/172; H04N 19/44

(57) ABSTRACT

A method and an apparatus of error handling for video bitstream decoding determines error types and frame types to select recovery techniques. The method receives a video bitstream, detects errors during decoding, and categorizes errors as syntax parsing errors, missing or corrupted reference picture data, or decoding errors. Frame types are classified as reference frames, non-reference frames, or keyframes. Based on these classifications, the method applies appropriate error handling: generating replacement reference data for partial corruption, dropping frames or frame groups for complete reference loss, performing row-level concealment for reference frames to limit error propagation, performing slice-level concealment for non-reference frames for visual quality, analyzing keyframe errors to ignore minor edge errors or drop frame groups for significant corruption, and dropping frames for unrecoverable syntax errors.

### CROSS REFERENCE TO RELATED APPLICATIONS

This application claims the benefit of U.S. Provisional Application No. 63/693,269, filed on September 11th, 2024. The content of the application is incorporated herein by reference.

### BACKGROUND

Digital video compression standards such as H.264/AVC and H.265/HEVC achieve high compression efficiency through inter-frame prediction, where frames reference previously decoded frames for reconstruction. This temporal dependency structure makes compressed video bitstreams highly sensitive to transmission errors, as corruption in a reference frame can propagate spatially and temporally, causing visual artifacts that persist across multiple subsequent frames. When video data is transmitted over error-prone channels such as wireless networks or broadcast systems, bit errors and packet loss can corrupt portions of the bitstream, necessitating robust error handling mechanisms at the decoder.

Traditional video decoders employ two primary error handling strategies: error concealment and frame dropping. Error concealment attempts to reconstruct missing or corrupted data using spatial or temporal interpolation, which maintains visual continuity but may introduce artifacts that propagate to dependent frames. Frame dropping discards corrupted frames entirely to prevent error propagation, but results in temporal discontinuities and degraded user experience. Conventional decoders typically implement a single, fixed error handling strategy regardless of the specific error characteristics or frame type, failing to account for the varying impact of different error types and the different roles of keyframes, reference frames, and non-reference frames in the video sequence. This inflexible approach results in suboptimal video quality and user experience in error-prone transmission environments.

### SUMMARY

An embodiment provides a method for error handling in a bitstream in a video decoder, comprising: receiving a bitstream comprising data associated with a sequence of frames, detecting an error during decoding of a frame in the sequence from the bitstream, determining an error type associated with the error, determining a frame type of the frame, and applying an error handling method based on the error type and the frame type.

In certain aspects, when the error type comprises missing or corrupted reference picture data, the method generates replacement reference picture data for partially corrupted data or drops frames based on frame type when reference data is completely unavailable.

In certain aspects, when the error type comprises a decoding error, the method performs row-level concealment for reference frames to limit error propagation, slice-level concealment for non-reference frames to maintain visual quality, or analyzes keyframe errors to either ignore small edge errors or drop frame groups for larger corruption.

In certain aspects, when the error type comprises a syntax parsing error, the method drops the frame if the error is unrecoverable.

In certain aspects, the method outputs the decoded frame when the applied error handling method does not result in dropping the frame.

An embodiment provides an apparatus for error handling in a bitstream in a video decoder, comprising memory configured to store executable instructions and a processor coupled to the memory and configured to execute the instructions to perform the error handling method described above.

To the accomplishment of the foregoing and related ends, certain embodiments comprise the features hereinafter fully described and particularly pointed out in the claims. The following description and accompanying drawings set forth in detail certain illustrative aspects of the embodiments. These aspects are indicative, however, of but a few of the various ways in which the principles of the embodiments may be employed, and the present disclosure is intended to include all such aspects and their equivalents. These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A and FIG. 1B illustrate a block diagram of an exemplary video coding system.

FIG. 2 illustrates a flowchart of the hybrid error handling method showing the decision processes according to an embodiment.

FIG. 3 illustrates a method for the hybrid error handling for video bitstream processing in a decoder according to an embodiment.

### DETAILED DESCRIPTION

Digital video compression standards such as H.264/AVC (Advanced Video Coding) and H.265/HEVC (High Efficiency Video Coding) have achieved high compression efficiency by employing sophisticated prediction techniques. To maximize compression efficiency, modern video codecs utilize inter-frame prediction, where frames are encoded with reference to previously decoded frames. This temporal prediction creates dependencies between frames, where a current frame may reference data from one or more previously decoded reference frames. Additionally, video frames are typically organized into Groups of Pictures (GOPs), with keyframes (I-frames) providing periodic refresh points, and predicted frames (P-frames and B-frames) depending on reference frames for reconstruction.

This inter-frame dependency structure makes compressed video bitstreams highly sensitive to transmission errors and data corruption. When video data is transmitted over error-prone channels such as wireless networks, the internet, or broadcast systems, bit errors, packet loss, and transmission delays can corrupt portions of the video bitstream. Due to the prediction dependencies inherent in video compression, a single bit error in a reference frame can propagate spatially and temporally, causing visual artifacts that persist across multiple subsequent frames.

Traditional video decoders have employed various error handling strategies to mitigate the effects of bitstream corruption. These approaches generally fall into two categories: error concealment and frame dropping.

Error concealment techniques attempt to reconstruct missing or corrupted video data by estimating the lost information from surrounding spatial or temporal context. Spatial error concealment uses pixel data from neighboring regions within the same frame, while temporal error concealment utilizes data from previously decoded frames. When a corrupted region is detected, the decoder fills in the missing data using interpolation, copying, or prediction techniques. While error concealment can maintain visual continuity and provide a complete video sequence, it may introduce visual artifacts, and if future frames reference the concealed areas, these artifacts can propagate and accumulate over time.

Frame dropping techniques, in contrast, discard corrupted frames entirely to prevent error propagation. When corruption is detected in a frame, the decoder simply omits that frame from the decoded sequence, effectively creating a temporal gap. While this approach prevents the spread of visual artifacts to subsequent frames, it results in motion discontinuities, temporal freezing, and degraded user experience, particularly when keyframes are dropped or when the interval between clean reference frames is large.

Conventional video decoders typically implement a single, fixed error handling strategy regardless of the specific characteristics of the detected error or the type of frame being processed. For example, a decoder might be configured to always perform error concealment, always drop corrupted frames, or use a simple threshold-based decision. This inflexible approach fails to account for the varying impact that different types of errors have on video quality and the different roles that various frame types play in the video sequence.

More specifically, existing techniques do not adequately consider that the optimal error handling strategy depends on multiple factors, including: (1) the type of error detected (e.g., syntax parsing errors, missing reference data, or decoding errors), (2) the type of frame affected (e.g., keyframes, reference frames, or non-reference frames), (3) the extent and location of the corruption within the frame, and (4) the potential impact on subsequent frames that may depend on the current frame for prediction.

For reference frames, aggressive error concealment may be visually acceptable for the current frame but can cause severe artifacts in subsequent frames that reference the concealed areas. Conversely, for non-reference frames, dropping the frame creates an unnecessary temporal gap since no future frames depend on the corrupted data. For keyframes, the decision may become even important, as keyframe corruption can affect an entire GOP, but small errors at frame edges may be visually imperceptible and safely ignored.

The failure of conventional methods to adaptively select error handling strategies based on these contextual factors results in suboptimal video quality, inefficient bandwidth utilization, and poor user experience in error-prone transmission environments.

This description provides an adaptive error handling method for video decoders that selects recovery strategies based on both the type of error detected and the characteristics of the affected frame. Unlike conventional approaches that apply a single error handling method regardless of context, the disclosed hybrid method includes analyzing multiple factors to determine the appropriate response to bitstream corruption.

Different types of errors require different handling approaches, and the optimal strategy depends on the role of the affected frame within the video sequence. For instance, corruption in a reference frame that will be used for predicting future frames requires a different approach than corruption in a non-reference frame that affects only the current display. Similarly, syntax parsing errors that prevent proper bitstream interpretation warrant different treatment than decoding errors that affect only specific regions within a frame.

The hybrid error handling method disclosed herein categorizes detected errors into distinct types, including syntax parsing errors, missing or corrupted reference picture data, and decoding errors. Simultaneously, the method includes determining the frame type of the affected frame, distinguishing between reference frames, non-reference frames, and keyframes, each of which plays a different role in the video decoding process and has different implications for error propagation. Based on this analysis of error type and frame type, the one of several error handling strategies may be selectively applied, including: generating replacement reference picture data for partially corrupted reference information; dropping individual frames or entire groups of pictures (GOPs) when reference data is completely unavailable; performing row-level error concealment for reference frames to limit propagation to dependent frames; performing slice-level error concealment for non-reference frames to maintain visual quality; analyzing error position and size within keyframes to determine whether to ignore minor edge errors or drop entire GOPs for larger corruption; and dropping frames when syntax parsing errors are unrecoverable.

This adaptive approach balances visual quality, temporal continuity, and error propagation prevention, providing improved video playback quality in error-prone transmission environments. The method is applicable to wireless video streaming, digital television broadcasting, and real-time video communication, where transmission errors occur and robust error handling is needed for maintaining acceptable user experience.

The following detailed description presents embodiments and implementations of the hybrid error handling method, including flowcharts illustrating the decision-making process, examples of different error scenarios, and descriptions of how the method adapts its response based on the combination of error type and frame type encountered during video decoding.

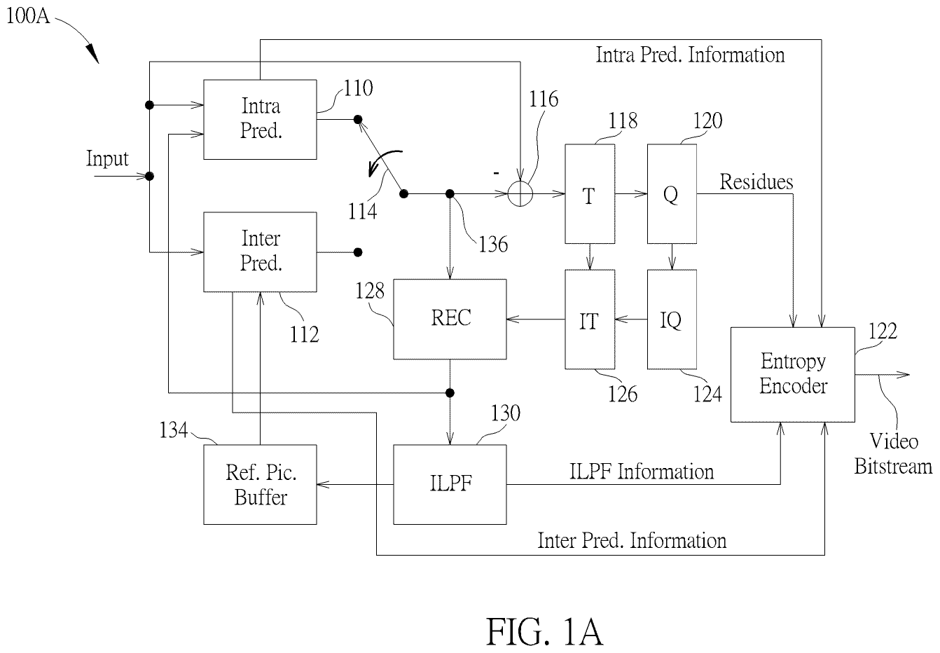

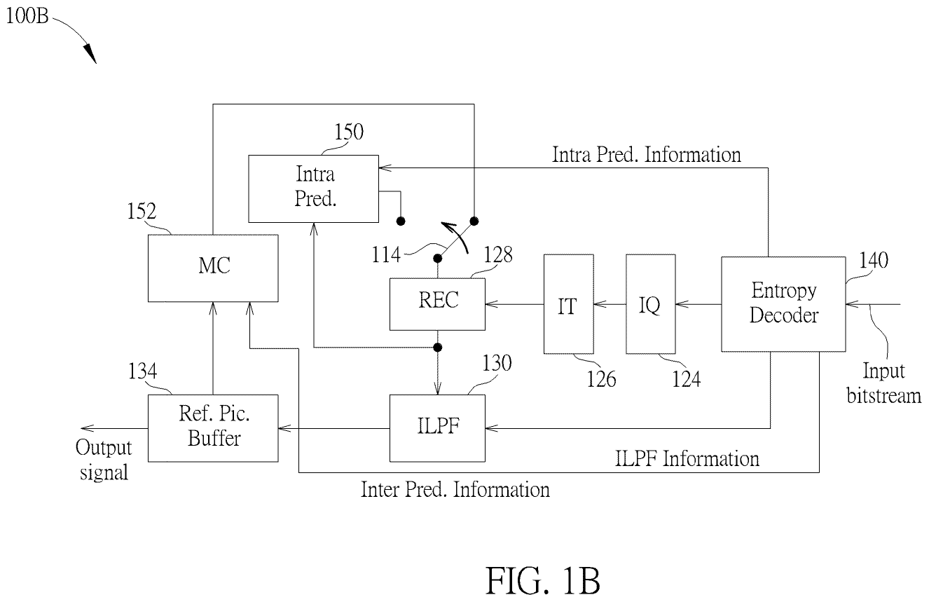

FIGS. 1A and 1B illustrates an exemplary adaptive inter/intra video coding system for performing video coding techniques described herein. The architecture of encoder 100A is shown in FIG. 1A. For intra-prediction module 110, the prediction data is derived based on previous coded video data in the current picture. For inter-prediction module 112, motion estimation (ME) is performed at the encoder side and motion compensation (MC) is performed based on the result of motion estimation to provide prediction data derived from other pictures and motion data. A selection switch 114 selects between intra-prediction module 110 or inter-prediction module 112, and the selected prediction data is supplied to an adder 116 to form prediction errors, also called residues. The residues are then processed by transform module (T) 118 followed by quantization module (Q) 120. The transformed and quantized residues are then coded by an entropy encoder 122 to be included in a video bitstream corresponding to the compressed video data. The bitstream associated with the transform coefficients is then packed with side information such as motion and coding modes associated with Intra-prediction and Inter-prediction, and other information such as parameters associated with loop filters applied to the underlying image area. The side information associated with Intra-prediction module 110, Inter-prediction module 112 and in-loop filter (ILPF) 130, are provided to the entropy encoder 122 as shown in FIG. 1A. When an inter-prediction mode is used, a reference picture or pictures have to be reconstructed at the encoder end as well. Consequently, the transformed and quantized residues are processed by inverse quantization module (IQ) 124 and inverse transform module (IT) 126 to recover the residues. The residues are then added back to prediction data 136 at a reconstruction module (REC) 128 to reconstruct video data. The reconstructed video data may be stored in a reference picture buffer 134 and used for prediction of other frames.

As shown in FIG. 1A, incoming video data undergoes a series of encoding operations in the encoding system. The reconstructed video data from REC 128 may be subject to various impairments due to these encoding operations. To improve video quality, an in-loop filter 130 is applied to the reconstructed video data before it is stored in the Reference Picture Buffer 134. The in-loop filter 130 may include multiple filtering operations such as a deblocking filter (DF), a sample adaptive offset (SAO), and an adaptive loop filter (ALF). Since a decoder needs to apply identical filtering operations, the loop filter information can be incorporated into the bitstream. Therefore, the loop filter information is provided to the entropy encoder 122 for incorporation into the encoded bitstream. As illustrated in FIG. 1A, the in-loop filter 130 processes the reconstructed video data before the filtered samples are stored in the reference picture buffer 134. This encoding system architecture shown in FIG. 1A represents an exemplary structure of a typical video encoder, which may be implemented in various video coding standards such as High Efficiency Video Coding (HEVC), VP8, VP9, Advanced Video Coding (H.264), or Versatile Video Coding (VVC).

The decoder 100B, as illustrated in FIG. 1B, shares several functional similarities with the encoder but operates in a complementary manner to reconstruct the original video data. Unlike the encoder which requires both transform module 118 and quantization module 120 for compression, the decoder may implement inverse quantization module 124 and inverse transform module 126 to reverse the compression process. In the decoder, the entropy decoder 140, replaces the entropy encoder 122 of the encoder. The entropy decoder 140 performs the task of interpreting the received video bitstream, extracting both the quantized transform coefficients and essential coding information, including ILPF information, Intra-prediction information, and Inter-prediction information.

The intra-prediction module 150 of the decoder can operate more efficiently than its encoder counterpart since it does not need to perform the computationally intensive mode search process. Instead, it directly generates the Intra-prediction signal by applying the intra-prediction information received from the entropy decoder 140. The information precisely specifies which prediction mode to use, reducing the need for the extensive mode evaluation process required at the encoder side.

Similarly, the Inter-prediction process at the decoder can be streamlined compared to the encoder. The motion compensation module (MC) 152 needs to execute the motion compensation operation based on the motion vectors and reference picture information received through the entropy decoder 140. This can be simpler than the Inter-prediction process of the encoder, which performs both motion estimation to find the best motion vectors and motion compensation to generate the prediction signal. The decoder can apply the received motion information to reconstruct the Inter-predicted blocks, accessing the necessary reference picture data from its reference picture buffer 134.

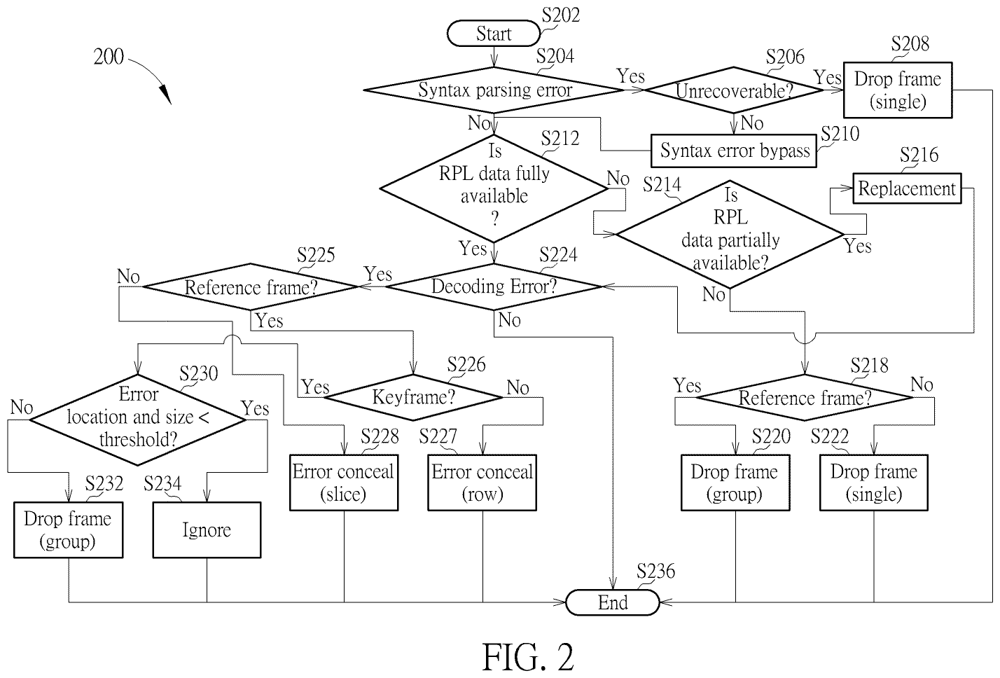

FIG. 2 illustrates a flowchart of a method 200 showing a decision-making process of the hybrid error handling for video bitstream processing in a decoder (e.g., decoder 100B) according to an embodiment. The flowchart demonstrates how the method determines an error type associated with detected errors, determines a frame type of the frame being processed, and applies an error handling method based on both the error type and frame type characteristics. The error type includes syntax parsing error, reference frame error and decoding error. Syntax parsing errors may occur during bitstream header interpretation and structural validation. Reference picture data errors may involve missing or corrupted pictures required for inter-prediction, and decoding errors that encompass issues occurring during coding tree unit (CTU) processing and pixel data reconstruction. Errors occurring during the processing of CTUs and pixel data reconstruction within the slice data portion are classified as decoding errors. Additionally, if the slice data includes invalid, unexpected, or out-of-range values, or if its structure does not conform to the expected syntax, these are also counted as decoding errors. The frame type includes the type of the current frame type and the type of the reference frame for the current frame. Keyframes provide independent decoding points. Reference frames can be used for predicting future frames, and non-reference frames can provide for current display without affecting subsequent frame decoding.

The process initiates at step S202 (Start) and immediately proceeds to step S204, where syntax parsing error detection is performed during decoding of a frame in the sequence from the bitstream. At step S204, the method determines whether a syntax parsing error has occurred during the parsing of NAL (Network Abstraction Layer) unit headers, slice headers, or other syntax elements.

When a syntax parsing error is detected at step S204, the method proceeds to step S206 to evaluate the severity of the syntax parsing error. At step S206, method determines whether the syntax parsing error is unrecoverable, meaning the bitstream structure is sufficiently corrupted that continued parsing would be unreliable or impossible.

If the syntax parsing error is unrecoverable at step S206, the method proceeds to step S208 to drop the frame. This represents one error handling method where the corrupted frame is discarded entirely to prevent propagation of syntax-level corruption.

If the syntax parsing error at step S206 is recoverable, the method proceeds to step S210 for syntax error bypass. This error handling method allows the decoder to continue processing despite minor syntax irregularities that do not fundamentally compromise the bitstream structure.

Following syntax error evaluation, or when no syntax parsing error is detected at step S204, the method proceeds to step S212 for reference picture list (RPL) data availability assessment. At step S212, a determination is made whether required reference picture data for the current frame is fully available in the decoded picture buffer.

At this step, the method determines an error type comprising missing or corrupted RPL data. This step examines the RPL data carried in the bitstream of the current frame. The RPL specifies which previously decoded pictures are required from the decoded picture buffer (DPB) to perform prediction for the current frame. The decoder verifies that all reference pictures listed in the RPL are actually present and accessible in the DPB.

When the RPL data is determined to be not fully available at step S212, the method proceeds to step S214 to assess partial availability. At step S214, a determination is made whether RPL data is partially corrupted or completely missing. This evaluation distinguishes between cases where some of the reference pictures in the RPL are missing or corrupted while others remain accessible, and cases where all required reference pictures are missing in the DPB.

If the RPL data is partially corrupted or missing at step S214, the method proceeds to step S216 to generate replacement reference picture data for the corrupted or missing portion.

When reference picture data is determined to be completely unavailable at step S214, the method proceeds to step S218 for frame type determination. At step S218, the frame type of the frame is determined, specifically evaluating whether the current frame is a reference frame or a non-reference frame.

If the frame type is a reference frame at step S218, the method proceeds to step S220 to drop a group of frames associated with the reference frame. This error handling method removes the entire group of pictures (GOP) to prevent temporal error propagation that would result from missing reference dependencies.

If the frame type is a non-reference frame at step S218, the method proceeds to step S222 to drop the single frame. Since non-reference frames do not serve as prediction sources for subsequent frames, individual frame removal does not create dependency chain failures.

When reference picture data is fully available at step S212, the method proceeds to step S224 for decoding error detection. At step S224, a determination is made whether a decoding error has occurred during macroblock processing, transform coefficient decoding, or motion vector reconstruction.

If no decoding error is detected at step S224, the method proceeds directly to step S236, concluding the error handling process with successful frame decoding.

When a decoding error is detected at step S224, the method proceeds to step S225 for frame type classification. At step S225, a determination is made whether the frame type is a reference frame, which can be used for prediction of subsequent frames.

If the frame type is a non-reference frame at step S225, the method proceeds to step S228 to perform slice-level concealment on one or more error regions within the non-reference frame. This error handling method applies comprehensive spatial concealment to entire affected regions to maintain visual integrity without concern for temporal error propagation.

If the frame type is a reference frame at step S225, the method proceeds to step S226 for keyframe classification. At step S226, a determination is made whether the frame type of the current frame is a keyframe, which serves as an independent decoding point and typically affects an entire GOP structure.

If the frame type is a keyframe at step S226, the method proceeds to step S230 for error region analysis. At step S230, an analysis is performed of error position and error region size within the keyframe, specifically evaluating whether the affected area size is below a predetermined threshold and whether the location of the error is at an edge of the frame.

If the affected area size of the error within the keyframe is below the predetermined threshold and the location of the error is at an edge of the keyframe at step S230, the method proceeds to step S234 to ignore the error. This error handling method recognizes that small errors at frame peripheries have minimal visual impact and can be safely disregarded.

When the error criteria at step S230 are not satisfied (the affected area exceeds the threshold or is not at frame edge), the method proceeds to step S232 to drop the group of frames associated with the keyframe. This error handling method can prevent significant visual artifacts from propagating throughout the GOP structure.

If the frame type is not a keyframe, the method proceeds to step S227 to perform row-level concealment on one or more error regions within the reference frame. This error handling method applies minimal spatial concealment to limit error propagation to dependent frames that will use this frame for prediction.

It should be noted that the sequence of step S225 and S226 is exchangeable for flexible implementations.

All error handling paths converge at step S236, where the hybrid error handling method concludes. Throughout the various error handling processes, when the applied error handling method does not result in dropping the frame, the decoded frame is output for display or further processing. This output occurs following successful application of error handling techniques such as replacement reference picture data generation, row-level concealment, slice-level concealment, or error bypass operations. The conditional output provides that frames that have been successfully processed or adequately concealed are passed to subsequent stages of the video decoding pipeline. The corrupted frames identified for dropping can be excluded from the output stream to maintain overall video quality and prevent error propagation.

The flowchart demonstrates the adaptive selection of error handling methods based on the systematic evaluation of error type characteristics (syntax parsing errors, missing or corrupted reference picture data, or decoding errors) combined with frame type properties (keyframe, reference frame, or non-reference frame). The exemplary technical implementation demonstrated by method 200 provides that each combination of error type and frame type receives optimized treatment, balancing visual quality preservation, temporal continuity maintenance, and error propagation prevention according to the specific characteristics of the detected corruption and the role of the affected frame within the video sequence structure.

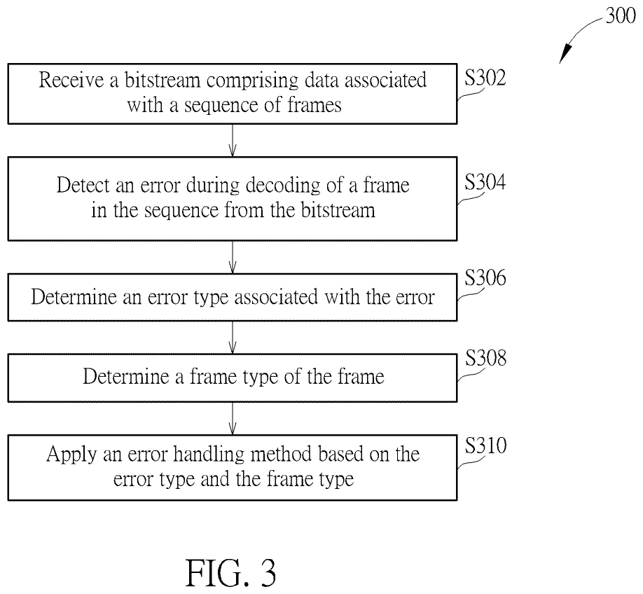

FIG. 3 illustrates a method 300 for the hybrid error handling for video bitstream processing in a decoder (e.g., decoder 100B) according to an embodiment. The method 300 represents the high-level procedural flow that encompasses the detailed decision-making process shown in FIG. 2, providing a systematic approach to adaptive error recovery based on contextual analysis of both error characteristics and frame properties. The method 300 includes the following steps:
S302: Receive a bitstream comprising data associated with a sequence of frames;
S304: Detect an error during decoding of a frame in the sequence from the bitstream;
S306: Determine an error type associated with the error;
S308: Determine a frame type of the frame; and
S310: Apply an error handling method based on the error type and the frame type.

At step S302, a bitstream is received comprising data associated with a sequence of frames. This step involves the acquisition and initial buffering of compressed video data that has been encoded according to video compression standards such as H.264/AVC or H.265/HEVC. The bitstream contains NAL (Network Abstraction Layer) units that encapsulate various types of video data including parameter sets, slice headers, and compressed frame data. The sequence of frames represents temporally ordered video content that may include different frame types such as intra-coded frames (I-frames), predictive frames (P-frames), and bidirectionally predictive frames (B-frames). The received bitstream may originate from various sources including network transmission, storage media, or broadcast channels, and may contain transmission errors, corruption, or missing data segments that occurred during encoding, transmission, or storage processes.

At step S304, error detection is performed during decoding of a frame in the sequence from the bitstream. This step encompasses multiple levels of error detection that occur throughout the decoding pipeline. Initial error detection involves parsing and validation of syntax elements within NAL unit headers, slice headers, and parameter set structures to identify malformed or invalid syntax constructs. Subsequent error detection occurs during the decoding process itself, where errors may be identified in transform coefficient decoding, motion vector reconstruction, reference picture management, or macroblock processing. The error detection mechanisms may use cyclic redundancy checks (CRC), parity bits, syntax validation rules, range checking of decoded parameters, and consistency verification between interdependent syntax elements. Errors detected at this step may range from minor syntax irregularities that can be bypassed to severe corruption that prevents meaningful frame reconstruction.

At step S306, an error type associated with the detected error is determined. This classification process categorizes errors into distinct types based on their characteristics, severity, and impact on the decoding process. The error type includes syntax parsing errors, missing or corrupted RPL data, and decoding errors that occur during the reconstruction of pixel data. Syntax parsing errors may include invalid parameter values, malformed headers, missing start codes, or violated syntax constraints. RPL data errors may include scenarios where previously decoded frames required for inter-prediction are unavailable, corrupted, or partially damaged. Decoding errors may include failures in transform coefficient processing, motion compensation, intra-prediction, or other reconstruction operations.

At step S308, the frame type of the current frame being processed is determined. This step involves analyzing frame characteristics to classify the current frame according to its role within the video sequence structure and its relationship to other frames. The frame type determination identifies whether the current frame is a keyframe (I-frame) that provides an independent decoding reference point, a reference frame that will be used for inter-prediction of subsequent frames, or a non-reference frame that serves only for current display without affecting future frame decoding. Additionally, the frame type analysis may distinguish between different prediction structures such as P-frames that reference previous frames and B-frames that may reference both previous and future frames. Different frame types have varying impacts on temporal error propagation, with reference frames potentially affecting multiple subsequent frames while non-reference frames have localized impact.

At step S310, an error handling method is applied based on both the error type determined in step S306 and the frame type determined in step S308. Error recovery strategies are adaptively selected through the combined consideration of error characteristics and frame properties. The error handling method application includes frame dropping, error concealment, reference picture data generation, and error bypass operations. For syntax parsing errors, frame dropping for unrecoverable errors or syntax bypass for recoverable errors may be applied. For RPL data issues, the techniques can be applied to generate of replacement reference picture data for partial corruption or drop frames or frame groups for complete reference loss. For decoding errors, the techniques can be applied different concealment granularities based on frame type, utilizing row-level concealment for reference frames to minimize propagation effects and slice-level concealment for non-reference frames to maximize visual quality.

Following the application of the error handling method at step S310, the method may include additional step to output the decoded frame when the applied error handling method does not result in dropping the frame. The conditional output step ensures that frames that have been successfully processed, adequately concealed, or effectively recovered through the hybrid error handling approach are forwarded to the display pipeline or subsequent processing stages. Frames subjected to replacement reference picture data generation, row-level concealment, slice-level concealment, or successful error bypass operations are deemed suitable for output, while frames identified for dropping due to unrecoverable syntax errors, complete reference picture data loss, or severe keyframe corruption can be excluded from the output stream. The adaptive nature of the method 300 provides for context-based error recovery, which outperforms conventional single-strategy approaches.

The terminology employed in the description of the various embodiments herein is intended for the purpose of describing particular embodiments and should not be construed as limiting. In the context of this description and the appended claims, the singular forms “a”, “an”, and “the” are intended to encompass plural forms as well, unless the context clearly indicates otherwise. It should be understood that the term “and/or” as used herein is intended to encompass any and all possible combinations of one or more of the associated listed items. Furthermore, the terms “includes,” “including,” “comprises,” and/or “comprising,” when used in this specification, indicate the presence of stated features, integers, steps, operations, elements, and/or components, but do not exclude the presence or addition of one or more other features, integers, steps, operations, elements, components, and/or groups thereof.

Unless specifically stated otherwise, the term “some” refers to one or more. Various combinations using “at least one of” or “one or more of” followed by a list should be interpreted to include any combination of the listed items, including individual items and multiple items. In the context of this disclosure, the terms “coupled,” “connected,” “connecting,” “electrically connected,” and similar expressions are used interchangeably to broadly denote the state of being electrically or electronically connected. Furthermore, an entity is deemed to be in “communication” with another entity when it electrically transmits and/or receives information signals to/from the other entity, irrespective of the signal type or transmission medium.

The use of ordinal designators like “first,” “second,” and so forth in the specification and claims serves to differentiate between multiple instances of similarly named elements. These designators do not imply any inherent sequence, priority, or chronological order but are employed solely as a means of uniquely identifying and distinguishing between separate instances of elements. The directional terms used in the embodiments such as up, down, left, right, upper-side, down-side, in front of or behind are just the directions referring to the attached figures and are for illustration purposes only.

As may be used throughout this specification and the appended claims, terms of approximation and degree such as “substantially,” “approximately,” “generally,” “essentially,” “nearly,” “about,” and similar expressions are used to account for variations in precision, manufacturing tolerances, measurement accuracy, environmental conditions, and inherent material properties. Such variations may range from ±20% in broader applications to progressively tighter tolerances of ±10%, ±5%, ±3%, ±2%, ±1%, or ±0.5% in more precise implementations. The specific degree of variation encompassed by these terms is informed by the nature of the component, relationship, or parameter being described and the understanding of one skilled in the relevant art.

The various illustrative components, logic, logical blocks, modules, circuits, operations and algorithm processes described in connection with the embodiments disclosed herein may be implemented as electronic hardware, firmware, software, or combinations thereof. The interchangeability of hardware, firmware and software depends upon the particular application and design constraints imposed on the overall system. The hardware and data processing apparatus utilized to implement the various components described herein may comprise one or more of the following: a general-purpose single-chip or multi-chip processor, a digital signal processor (DSP), an application specific integrated circuit (ASIC), a field programmable gate array (FPGA), other programmable logic devices, discrete gate or transistor logic, discrete hardware components, or any suitable combination thereof.

A general-purpose processor may include a microprocessor, or alternatively, any conventional processor, controller, microcontroller, or state machine. In certain implementations, a processor may be realized as a combination of computing devices, such as a DSP and a microprocessor, a plurality of microprocessors, one or more microprocessors in conjunction with a DSP core, or any other suitable configuration. In some embodiments, particular processes, operations, or methods may be executed by circuitry specifically designed for a given function, with such function-specific circuitry optimized to enhance performance, efficiency, or other relevant metrics.

In certain aspects, the subject matter described herein may be implemented as software. Various functions of the disclosed components, or steps of the methods, operations, processes, or algorithms described herein, may be realized as one or more modules within one or more computer programs. These computer programs may comprise non-transitory processor-executable or computer-executable instructions, encoded on one or more tangible processor-readable or computer-readable storage media. Such storage media may include Random Access Memory (RAM), Read Only Memory (ROM), Electrically Erasable Programmable Read-Only Memory (EEPROM), Compact Disc Read-Only Memory (CD-ROM) or other optical disk storage, magnetic disk storage or other magnetic storage devices, or any other medium capable of storing program code.

Various modifications to the embodiments described in this disclosure may be readily apparent to persons having ordinary skill in the art, and the generic principles defined herein may be applied to other embodiments without departing from the spirit or scope of this disclosure. Thus, the claims are not intended to be limited to the embodiments shown herein, but are to be accorded the widest scope consistent with this disclosure. Various features that are described in this specification in the context of separate embodiments also can be implemented in combination in a single implementation. Conversely, various features that are described in the context of a single implementation also can be implemented in multiple embodiments separately or in any suitable subcombination.

The depiction of operations in a particular sequence in the drawings should not be construed as a requirement for strict adherence to that order in practice, nor should it imply that all illustrated operations must be performed. Additional, unillustrated operations may be incorporated at various points within the depicted sequence, occurring before, after, simultaneously with, or between any of the illustrated operations. The various figures and component diagrams presented are provided for illustrative purposes only and are not drawn to scale, intended to facilitate understanding of the described embodiments without limiting the scope of the invention to the specific arrangements depicted.

While the invention has been described in connection with certain embodiments, it will be understood by those skilled in the art that various modifications and adaptations can be made without departing from the scope of the invention. The specific embodiments presented are intended to illustrate the invention and not to limit its application or construction. Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for error handling for a bitstream in a video decoder, comprising:
receiving a bitstream comprising data associated with a sequence of frames;
detecting an error during decoding of a frame in the sequence from the bitstream;
determining an error type associated with the error;
determining a frame type of the frame; and
applying an error handling method based on the error type and the frame type.

2. The method of claim 1, wherein the error type comprises missing or corrupted reference picture data, and applying the error handling method comprises:
in response to determining that the reference picture data is partially corrupted, generating replacement reference picture data for a corrupted portion.

3. The method of claim 1, wherein the error type comprises missing or corrupted reference picture data and applying the error handling method comprises:
in response to determining that the reference picture data is completely unavailable and the frame type comprises a non-reference frame, dropping the frame; or
in response to determining that the reference picture data is completely unavailable and the frame type comprises a reference frame, dropping a group of frames associated with the reference frame.

4. The method of claim 1, wherein the error type comprises a decoding error and the frame type comprises a reference frame, and applying the error handling method comprises:
performing row-level concealment on one or more error regions within the reference frame.

5. The method of claim 1, wherein the error type comprises a decoding error and the frame type comprises a non-reference frame, and applying the error handling method comprises:
performing slice-level concealment on one or more error regions within the non-reference frame.

6. The method of claim 1, wherein the error type comprises a decoding error and the frame type comprises a keyframe, and applying the error handling method comprises:
in response to determining that an affected area size of the error within the keyframe is greater than a predetermined threshold or a location of the error within the keyframe is not at an edge of the frame, dropping a group of frames associated with the keyframe.

7. The method of claim 1, wherein the error type comprises a decoding error and the frame type comprises a keyframe, and applying the error handling method comprises:
in response to determining an affected area size of the error within the keyframe is below a predetermined threshold and a location of the error is at an edge of the keyframe, ignoring the error.

8. The method of claim 1, wherein the error type comprises a syntax parsing error, and applying the error handling method comprises:
in response to determining the syntax parsing error is unrecoverable, dropping the frame.

9. The method of claim 1, further comprising outputting the decoded frame in response to applying the error handling method and determining that the frame is not to be dropped.

10. An apparatus of error handling for a bitstream in a video decoder, comprising:
memory configured to store executable instructions; and
a processor coupled to the memory, and configured to execute the instructions to:
receive a bitstream comprising data associated with a sequence of frames;
detect an error during decoding of a frame in the sequence from the bitstream;
determine an error type associated with the error;
determine a frame type of the frame; and
apply an error handling method based on the error type and the frame type.

11. The apparatus of claim 10, wherein the processor is further configured to:
in response to determining that the error type comprises missing or corrupted reference picture data and the reference picture data is partially corrupted, generate replacement reference picture data for a corrupted portion.

12. The apparatus of claim 10, wherein the processor is further configured to:
in response to determining that the error type comprises missing or corrupted reference picture data and the reference picture data is completely unavailable:
if the frame type comprises a non-reference frame, drop the frame; or
if the frame type comprises a reference frame, drop a group of frames associated with the reference frame.

13. The apparatus of claim 10, wherein the processor is further configured to:
in response to determining that the error type comprises a decoding error and the frame type comprises a reference frame, perform row-level concealment on one or more error regions.

14. The apparatus of claim 10, wherein the processor is further configured to:
in response to determining that the error type comprises a decoding error and the frame type comprises a non-reference frame, perform slice-level concealment on one or more error regions.

15. The apparatus of claim 10, wherein the processor is further configured to:
in response to determining that the error type comprises a decoding error and the frame type comprises a keyframe:
if an affected area size of the error within the keyframe is greater than a predetermined threshold or a location of the error within the keyframe is not at an edge of the frame, drop a group of frames associated with the keyframe.

16. The apparatus of claim 10, wherein the processor is further configured to:
in response to determining that the error type comprises a decoding error and the frame type comprises a keyframe:
if an affected area size of the error within the keyframe is below a predetermined threshold and a location of the error is at an edge of the keyframe, ignore the error.

17. The apparatus of claim 10, wherein the processor is further configured to:
in response to determining that the error type comprises a syntax parsing error and the syntax parsing error is unrecoverable, drop the frame.

18. The apparatus of claim 10, wherein the processor is further configured to output the decoded frame if the frame is not dropped during error handling.
